(19) United States
(12) Patent Application Publication
(10) Pub. No.: US 2026/0308860 A1
(43) Pub. Date: Oct. 8, 2026

(54) POLLUTION CLEANUP USING A SUBMERGED APPARATUS

(71) Applicant: OceanWell Co., Menlo Park, CA (US)

(72) Inventors: Mark Golay, Menlo Park, CA (US); Michael Porter, Menlo Park, CA (US); Michael Gerdes, Menlo Park, CA (US); Robert A. Bergstrom, Menlo Park, CA (US)

(21) Appl. No.: 19/677,854

(22) Filed: May 14, 2026

Related U.S. Application Data
(63) Continuation of application No. PCT/US2024/056247, filed on Nov. 15, 2024.
(60) Provisional application No. 63/599,515, filed on Nov. 15, 2023.

(51) Int. Cl. E02B 15/10; A01M 29/10; E02B 15/08

(52) U.S. Cl. CPC E02B 15/10; A01M 29/10; E02B 15/08

(57) ABSTRACT

A submerged, multi-stage filtration system captures suspended solids from a water source. The filtration system includes an intake filter subsystem fluidically coupled to the water source and to at least one pump, the intake filter subsystem configured to receive a flow of source water, capture suspended non-living solids and living solids from the flow of source water, and produce a flow of filtered water. In a first operating mode, the filtered flow of water is provided along a first fluid pathway to produce filtered water at a first system outlet; and in a second operating mode, the filtered flow of water is provided along a second fluid pathway to wash captured non-living solids and living solids into the collection subsystem and release living solids through a second system outlet back into the water source.

### CROSS REFERENCE TO RELATED APPLICATIONS

This application is a continuation of International Application No. PCT/US2024/056247 filed Nov. 15, 2024 and entitled POLLUTION CLEANUP USING A SUBMERGED APPARATUS, which claims priority to U.S. Provisional Application Ser. No. 63/599,515 filed Nov. 15, 2023 and entitled WATER INTAKE FILTRATION SYSTEM WITH SELF-CLEANING APPARATUS, the disclosures of which are incorporated herein by reference.

### TECHNICAL FIELD

This invention relates to a device, system, and method for collecting and entrapping suspended solids (e.g., microplastics) from a water source. The present invention also relates to a submerged processing device, system, and method for collecting and entrapping pollutants from a water source.

### BACKGROUND

Water bodies around the world are polluted from various sources that impact both planetary health and human wellness. Water pollution often originates from urban and agricultural runoff, atmospheric transport, industrial discharges, and untreated sewage. As pollutants enter inland water bodies and flow downstream into larger systems, such pollutants have been found to disrupt terrestrial and aquatic habitats leading to biodiversity loss. Further, human communities relying on these water sources for drinking, agriculture, and recreation may face health risks and economic setbacks caused by polluted water sources.

Generally, water pollutants can be classified by their behavior: floating, e.g., oil spills and physical debris resulting in surface contamination; sinking, e.g., heavy metals and sediments that settle at a water bottom and negatively impact benthic ecosystems; suspended, e.g., microparticles including microplastics; and dissolved, e.g., excess minerals, excess nutrients, toxic chemicals, other toxins, volatile organic compounds (VOCs), anthropogenic carbon, dissolved gases and other chemicals that can become entrained and remain in a water column. Each type of pollutant poses distinct challenges for the environment and economy. For instance, floating pollutants can harm marine life and hinder navigation, sinking pollutants can negatively affect sediment quality and habitat integrity, and suspended or dissolved pollutants can lead to water quality deterioration with negative implications for human health and ecosystem balance.

Microplastics, often defined as plastic particles less than 5 mm in size, or as plastic particles from 1 micrometer to 5 mm in size, have gained considerable attention due to their relatively recent ubiquity in nature. Microplastics may originate from a variety of sources, e.g., a breakdown of larger plastic debris, microbeads in industrial and personal care products, rubber from automotive tires, and degradation of synthetic textiles. The most common microplastic forms are fragments and fibers composed of polyester, polypropylene or polyethylene. Once released into the environment, microplastics have been found to travel vast distances via air currents and waterways. As a result, microplastics have become widely distributed across numerous terrestrial, aquatic, and marine ecosystems.

Once in the environment, microplastics may pose a range of threats to humans and wildlife via ingestion, bioaccumulation, habitat degradation, and their ability to adsorb and transport harmful chemicals, e.g., organic pollutants. Further, numerous studies have found microplastics in drinking water, seafood, and agricultural soils, raising concerns about their potential impact through direct exposure or consumption. While most attention has focused on microplastics in the oceans, freshwater bodies (lakes, reservoirs, etc.) have also been found to accumulate microplastics at rates comparable to, or higher, than those in marine systems. For example, a recent study has found higher concentrations of microplastics in Lake Tahoe, CA than comparable oceans.

Current efforts to mitigate water pollution include regulatory measures, sustainable practices, and effective waste management strategies, e.g., pollution cleanup or decarbonization projects. For example, the Ocean Cleanup organization and the Seabin Foundation both focus on physically removing floating debris from oceans, rivers, and harbors. Specialized robots, nets, barriers or vacuums have also been employed or proposed for capturing and removing sinking debris.

Cleanup of suspended or dissolved pollutants can be more difficult or less practical, and may for example require chemical or biological remediation methods to break down excessive nutrients and toxins into less harmful substances. Aeration has also been used to increase oxygen levels and promote healthy bioprocesses. However, while potentially effective, methods like these may require an intimate knowledge of local water quality, ecological activity, and environmental flows. If improperly managed, small changes in water chemistry or aquatic biology may lead to harmful unintended impacts. Therefore, what is needed are improved systems and methods for capturing and removing microparticles, microplastics and other suspended non-living solids from a water source.

### SUMMARY

In some embodiments, the present disclosure provides a submerged, multi-stage filtration system for capturing suspended solids from a water source. In one example, a filtration system includes a source water intake, first and second system outlets, at least one pump, and an intake filter subsystem fluidically coupled to the source water intake and the at least one pump, the intake filter subsystem configured to receive a flow of source water, capture suspended non-living solids and living solids from the flow of source water, and produce a filtered flow of water. The filtration system also includes a collection subsystem fluidically coupled to the second system outlet and configured to capture non-living solids and living solids and to separate non-living solids from living solids. The system is configured to operate in a plurality of operating modes, and in a first operating mode, the filtered flow of water is provided along a first fluid pathway to produce filtered water at the first system outlet; and in a second operating mode, the filtered flow of water is provided along a second fluid pathway to wash captured non-living solids and living solids into the collection subsystem and release living solids through the second system outlet back into the water source.

In additional embodiments, a method for capturing suspended solids from a water source is also disclosed. The method includes flowing source water through a submerged, multi-stage filtration system. The filtration system includes a source water intake, first and second system outlets, at least one pump, and an intake filter subsystem fluidically coupled to the source water intake and the at least one pump, the intake filter subsystem configured to receive a flow of source water, capture suspended non-living solids and living solids from the flow of source water, and produce a flow of filtered water. The system also includes a collection subsystem fluidically coupled to the second system outlet and configured to capture non-living solids and living solids and to separate non-living solids from living solids. The method also includes operating the system in a first operating mode comprising pumping filtered water from the intake filter subsystem along a first fluid pathway to produce filtered water at the first system outlet, and, operating the system in a second operating mode comprising pumping filtered water along a second fluid pathway to wash captured non-living solids and living solids into the collection subsystem and release living solids into the water source through the second system outlet.

Portions of the above-mentioned first and second fluid pathways may be the same. In some embodiments, the flow of filtered water along the second fluid pathway travels through an interstitial space between successive filters to wash captured non-living solids and living solids into the collection subsystem. In some embodiments, the collected non-living solids comprise microparticles, and in additional embodiments the collected non-living solids comprise microplastics. In some embodiments the released living solids comprise unicellular or multicellular organisms, and in additional embodiments the released living solids comprise microorganisms.

Separation of the collected non-living solids and living solids may be performed in a variety of ways, for example by using a light source or other attractant that causes the living solids to swim or otherwise migrate through an opening or openings in the collection system and enables them to be returned to the water source. The remaining collected non-living solids may be agglomerated, encapsulated or brought topside for disposal or recycling.

### BRIEF DESCRIPTION OF THE DRAWING

FIG. 1A is a submerged, multi-stage water filtration system operating in a first intake operating mode in accordance with an embodiment of the present invention.

FIG. 1B is a submerged, multi-stage water filtration system operating in a second, backflush or backwash, operating mode in accordance with an embodiment of the present invention.

FIG. 2 is a block diagram of a submerged, multi-stage water filtration system in accordance with an embodiment of the present invention.

FIG. 3A illustratively shows a forward operating mode of a submerged, multi-stage water filtration system with desalination membranes in accordance with an embodiment of the present invention.

FIG. 3B illustratively shows a cleaning operating mode of a submerged, multi-stage water filtration system with desalination membranes in accordance with an embodiment of the present invention.

FIG. 3C illustratively shows another cleaning operating mode of a submerged, multi-stage water filtration system with desalination membranes in accordance with an embodiment of the present invention.

FIG. 3D illustratively shows a backwash operating mode of a submerged, multi-stage water filtration system with desalination membranes in accordance with an embodiment of the present invention.

FIGS. 4A-4J illustratively show various submerged, multi-stage water filtration systems in accordance with embodiments of the present invention.

FIGS. 5A-5E illustratively show a cleaning subsystem of a submerged multi-stage filtration system in accordance with embodiments of the present invention.

### DETAILED DESCRIPTION

The recitation of a numerical range using endpoints includes all numbers subsumed within that range (e.g., 1 to 5 includes 1, 1.5, 2, 2.75, 3, 3.80, 4, 5, etc.).

The terms “a,” “an,” “the,” “at least one,” and “one or more” are used interchangeably. Thus, for example, an apparatus that contains “a” reverse osmosis membrane includes “one or more” such membranes.

The term “backflush” when used with respect to a mode or event refers to a flow of filtered water through a flow path that discharges suspended solids and organisms from one or more interstitial spaces in the flow path into a collection system or into source water.

The term “backwash” refers to a combination or sequence of cleaning or backflush modes for dislodging and washing solids and organisms from one or more filters into a collection system or into source water.

The term “brine” refers to an aqueous solution containing a materially greater sodium chloride concentration than that found in typical saltwater, viz., salinity corresponding to greater than about 3.5% sodium chloride. It should be noted that different jurisdictions may apply differing definitions for the term “brine” or may set different limitations on saline discharges. For example, under current California regulations, discharges should not exceed a daily maximum of 2.0 parts per thousand (ppt) above natural background salinity measured no further than 100 meters horizontally from the discharge point. In other jurisdictions, salinity limits may for example be set at levels such as 1 ppt above ambient, 5% above ambient, or 40 ppt absolute.

The term “cleaning” when used with respect to a mode or event refers to a physical process for dislodging impinged matter from one or more filters using brushes, water jets, air bursts, backpressure or other such techniques.

The term “concentrate” refers to a desalination apparatus discharge stream having an elevated salinity level compared to ambient surrounding seawater, but not necessarily containing sufficient salinity to qualify as brine in the applicable jurisdiction where such stream is produced.

The term “conduit” refers to a pipe or other hollow structure (e.g., a bore, channel, duct, hose, line, opening, passage, riser, tube or wellbore) through which a liquid flows during operation of an apparatus employing such conduit. A conduit may be but need not be circular in cross-section, and may for example have other cross-sectional shapes including oval or other round or rounded shapes, triangular, square, rectangular or other regular or irregular shapes. A conduit also may be but need not be linear or uniform along its length, and may for example have other shapes including tapered, coiled or branched (e.g., branches radiating outwardly from a central hub).

The term “depth” when used with respect to a submerged apparatus or a component thereof refers to the vertical distance, viz., to the height of a water column, from the free surface of a body of water in which the apparatus or component is submerged to the point of seawater introduction into the apparatus or to the location of the component.

The terms “desalinated water”, “fresh water” and “product water” refer to water containing less than 1000 parts per million (ppm), and more preferably less than 500 ppm, dissolved inorganic salts by weight. Exemplary such salts include sodium chloride, magnesium sulfate, potassium nitrate, and sodium bicarbonate.’

The term “flow across” when used with respect to a filter having an upstream and downstream face and passages between the upstream and downstream faces through which filtrate can flow and in which retentate can be trapped, means a flow along a filter face rather than through the filter passages.

The term “fluid pathway” refers to the conduit(s), filter(s), interstitial space(s) and pump(s) through which a fluid may move in a chosen direction. The terms “first fluid pathway” and “second fluid pathway” refer to fluid pathways that are distinct (but which may include some path elements in common), and whose distinctness is not merely having identical path elements with different fluid flow directions along those elements.

The term “interstitial space” refers to a fluid flow path across a filter face between a downstream side of an upstream filter and an upstream side of a downstream filter.

The terms “living solids” and “organisms” are, for the purposes of the present disclosure, interchangeable, and mean organic matter that contains nucleic acids and can evolve. Organisms may be microorganisms, unicellular or multicellular, and include neuston, plankton, nekton, and benthos organisms that may be captured, entrapped, entrained, or impinged upon by subsea filtration of source water.

The term “microorganisms” means organisms that can be seen only though a microscope.

The term “microparticles” when used with respect to suspended pollutants refers to particles from 1 micrometer to 5 mm in size.

The term “multi-stage” when used with respect to a filtration system means that the system includes two or more filters arranged in series and having progressively smaller filtrant passages.

The term “offshore” refers to an apparatus, system or method that is situated or performed at sea, and at some distance from the shore.

The term “onshore” refers to an apparatus, system or method that is situated or performed on land.

The term “platform” refers to a supporting surface, typically level and flat, and typically raised with respects to its surroundings, on which equipment may be mounted. Offshore platforms may in some embodiments be non-level, non-flat, or partially or wholly submerged.

The term “seawater” refers to water containing more than 0.5 ppt dissolved inorganic salts by weight, and thus encompassing both brackish water (water containing 0.5 to 3.0 ppt dissolved organic salts by weight) as well as ocean water or other water containing more than 3.0 ppt dissolved organic salts by weight. In oceans, dissolved inorganic salts typically are measured based on Total Dissolved Solids (TDS), and typically average about 35 ppt TDS, though local conditions may result in higher or lower levels of salinity.

The term “solids” means water-insoluble matter, including living solids, particulates, suspended matter, microparticles, foulants, detritus, or debris that may be captured, entrapped, entrained, or impinged upon by subsea filtration of source water.

The term “submerged” means underwater.

The term “submersible” means suitable for use and primarily used while submerged.

The term “topside” means above the surface of a body of water, e.g., above sea level for body of ocean water.

The disclosed submerged, multi-stage filtration system may remove suspended solids, e.g., microplastics, from nearly any body of water. For example, the filtration system may be used in ocean water, seas, gulfs, bays, estuaries, reservoirs, lake water, river water, or pond water. Such sources may contain microplastics or other unwanted solids, including freshwater bodies of water such as Lake Tahoe, California, Lake Lugano, Switzerland, and Lake Maggiore, Switzerland. Additional sources may include the onshore or offshore waters of Australia, the United States, the Mediterranean Sea, the Indian Ocean, and other bodies of seawater. Within a desired water source, the present filtration system may be situated or positioned at nearly any operating depth to capture unwanted solids. Such depths may include a depth of at least 50, at least 100, at least 200, at least 300, at least 400, at least 500 or at least 600 meters below sea level. However, it is to be understood that these are mere examples and that other operating depths may also suffice.

In an embodiment, a submerged, multi-stage water filtration system is disclosed for filtering out and entrapping suspended solids, e.g., microplastics, from a water source. A submerged, multi-stage water filtration system may include an intake subsystem with one or more successive filters for receiving and filtering out suspended solids from a flow of water, one or more pumps for driving a flow of liquid into and out of the submerged, multi-stage water filtration system, a valving assembly for directing a flow of liquid through the system, a control system for switching or modifying an operating mode of the submerged system, and a collection subsystem for entrapping suspended solids.

In embodiments, the submerged, multi-stage water filtration system of the present disclosure may operate in any number of operating modes to remove suspended solids, e.g., microplastics, from a surrounding water source. For example, in an intake operating mode, or first operating mode, a control system of the filtration system may operate one or more pumps in a forward direction to drive a flow of surrounding water into an intake subsystem of the filtration system. As a flow of surrounding water is received, successive filters of the intake subsystem may capture or otherwise filter out suspended solids (for example, microparticles and organisms) within a space between the one or more successive filters, hereinafter an “interstitial space”. As suspended solids are captured or aggregated within the interstitial space, filtered water that makes it through the multi-stage filter system may travel along one or more fluid passageways within the filtration system to any number of internal or external downstream applications. In a second operating mode, a control system of the submerged system may use a cleaning or backflush operation (or a backwash operation that may for example use both cleaning and backflush) to dislodge suspended solids from one or more of the filter stages. For example, by operating the one or more pumps in reverse and rerouting the fluid flow (for example, by actuating a valve), a pressure differential can be created to redirect filtered water back through one or more filters of the intake subsystem and into a collection subsystem. As a result, non-living solids and living solids impinged on the one or more filters may be dislodged and collected. Switching between or selecting among intake, cleaning, backflush and backwash operating modes may occur based on one or more qualifying events. Qualifying events may include a passage of time, a presence or quantity of suspended solids, a pressure drop, or other indicators of potential filter clogging.

Further details regarding the disclosed subsystems and operating modes are described in detail in copending International Application No. (Attorney Docket No. 40031-155), filed even date herewith and entitled Water Intake Filtration System, the disclosure of which is incorporated herein by reference.

Following collection of solids, collected living solids are caused to migrate away from other collected solids (e.g., by using light or another attractant) and are returned to the source water. Doing so helps preserve aquatic balance and may restore the returned source water to or towards conditions that prevailed prior to the introduction of microparticles, microplastics or other non-living solids into the source water. In embodiments, the disclosed system returns at least 10 %, at least 20%, at least 30%, at least 40%, at least 50%, at least 60%, at least 70%, at least 80% or at least 90% of the captured living solids (e.g., organisms or microorganisms) alive to the water source.

The collected non-living solids may be agglomerated (e.g., by heating or otherwise processing them to increase their size or density so that they no longer will be suspended in the water column), encapsulated (e.g., by coating them with a suitable material to increase their size or density so that they no longer will be suspended in the water column) or brought topside for disposal or recycling. In embodiments, the disclosed system removes at least 10 %, at least 20%, at least 30%, at least 40%, at least 50%, at least 60%, at least 70%, at least 80% or at least 90% of the captured non-living solids from the source water. Using the present filtration system, suspended solids, e.g., microplastics, may be effectively and efficiently collected and disposed of. In turn, this may enhance purity of the surrounding water and reduce or otherwise eliminate known or potential risks to humans and ecosystems. For example, through ingestion, bioaccumulation, habitat degradation, and adsorption of harmful chemicals, such solids, e.g., microplastics, have been found to disrupt ecosystems and cause negative health defects. As a result, through their effective and efficient removal, many of these risks may be mitigated.

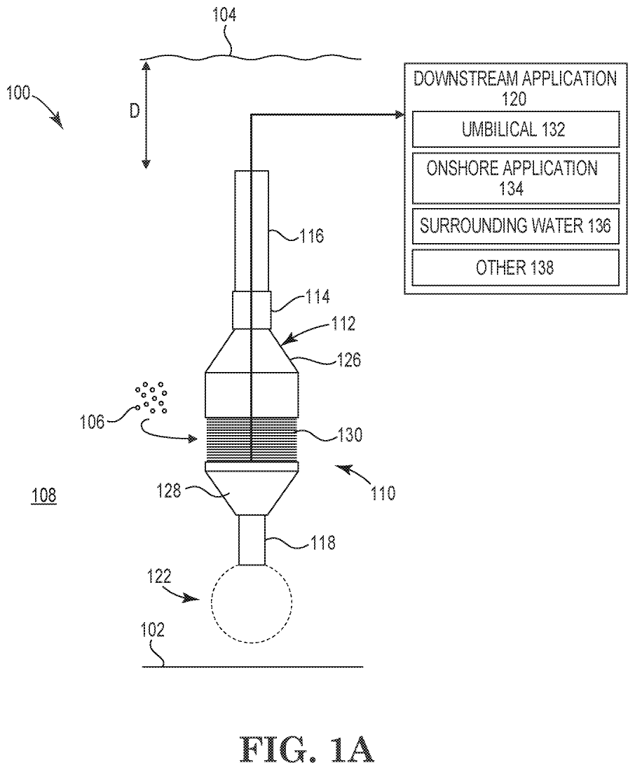

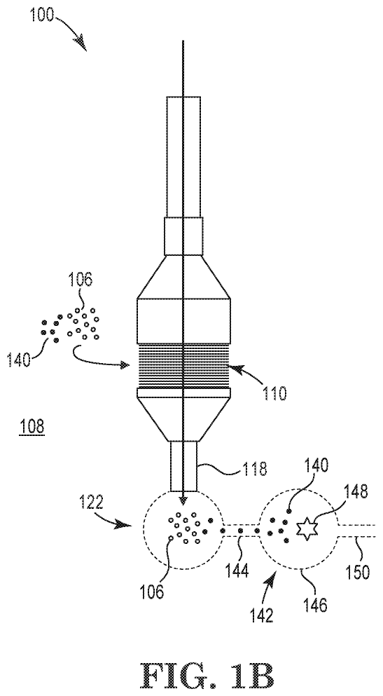

FIG. 1A is a submerged, multi-stage water filtration system operating in a first intake mode in accordance with an embodiment of the present invention. As shown, in a first intake mode, water filtration system 100 operates at or close to a floor 102 or sufficiently below a water surface 104 to collect or otherwise entrap suspended solids 106 from a surrounding body of water 108 while producing a flow of filtered water for one or more downstream application(s) 120. Downstream application(s) 120 may include a filtration assembly umbilical 132, onshore application 134, surrounding water 136, or any other application 138. To maintain an operating position, system 100 may be tethered to seafloor 102, suspended from a fixed platform on seafloor 102, or otherwise coupled to a multi-filtration system housing (not shown). Exemplary coupling and suspension mechanisms may be available from a variety of suppliers including Applicant OceanWell Co.

To produce filtered water (a first, intake mode) or carry out a suspended solid removal operation (a second backflush or backwash mode of operation), system 100 may include one or more mechanical or electrical subsystems. For example, system 100 may include an intake subsystem 110 with two or more successive filter stages for receiving and filtering suspended solids 106 from a flow of surrounding water 108, a housing 112 defining one or more fluid passages for circulating flows of unfiltered and filtered water, one or more pumps 114 for driving movement of water into and out of system 100, a valving assembly (not shown) for directing flows of unfiltered and filtered water within housing 112, and an outfall 116 and discharge outlet 118 for providing filtered water and suspended solids to downstream application 120 and collection subsystem 122, respectively.

Depending on an environment of system 100, housing 112 may have a variety of shapes and sizes. Specifically, while a cylindrical housing 112 with a discharge hood 126 and a structural cone 128 is shown, it is to be understood this is only one embodiment. For example, in smaller bodies of water, it may be desirable for housing 112 to have a rectangular or circular shape with intake subsystem 110 on one side of housing 112. Housing 112 may have virtually any shape and size so long as pump(s) 114 can direct a flow of surrounding water through successive filters of intake subsystem 110 to entrap or otherwise capture suspended solids within an interstitial space between successive filters.

Pump(s) 114 may be inline axial or mixed flow pumps or similar high-volume/low-pressure pumps that can move large volumes of fluid, while overcoming the relatively low-pressure drops induced by upstream or downstream equipment, such as multi-stage filters or submerged reverse osmosis membrane elements. Axial/mixed flow pumps are especially desirable, because when run at low speed, they produce minimal pressure changes, shearing, and turbulence. However, other pump styles that produce greater pressure differentials, e.g., centrifugal or displacement pumps, may be used instead or as well.

Intake subsystem 110 may include any number and type of successive filters with openings sufficiently sized to entrap suspended solids within an interstitial space between filter stages. For example, as illustratively shown, intake subsystem 110 may include an outer concentric filter 130 exposed to surrounding water 108 and one or more interior filters or stages (not shown) within housing 112. In this embodiment, outer concentric filter 130, or the first filtration stage, may include a courser porosity or larger opening size as compared to the finer and smaller openings of the one or more interior filter(s), e.g., second, third, fourth, etc. filtration stages. In some embodiments, successive filtration stages, from outer concentric filter 130 to interior concentric filters, include successively smaller openings, pore diameters, slot widths, or channel sizes for filtering out ever decreasing sizes of solids, e.g., aquatic lifeforms, detritus, and other suspended particulate matter. In turn, suspended solids 106 smaller than an opening size of outer filter 130, but larger than an opening size of one or more inner filter(s), may become entrained, suspended, or impinged onto an outer surface of the inner filters or otherwise captured within an interstitial space between the outer 130 and interior filters.

To securely position or fasten intake subsystem 110 to housing 112, one or more support structures or load-bearing members (not shown), may be used to support each filter stage. Such structures may be fully or partially integrated with, or separate from, the filtration media so that each filter can be easily maintained or replaced.

While concentric cylindrical filters may be used, in other embodiments, intake subsystem 110 may include two or more filters in the form of flat sheets or other flat, curved, or pleated surfaces with open porosities. Exemplary filter materials include wedge wire screens, woven textiles, nonwoven fabrics (e.g., felt fabrics), and other open porosity filters; granular media such as packed sand, gravel, or anthracite; and other mechanical, chemical, electromagnetic, or biologically selective or non-selective, depth or surface filtration materials or systems. In some embodiments, surface filtration structures, such as screens or woven textiles, may be preferred. Also, exemplary filter materials may include a single material or a combination of materials, e.g., metal, plastic, composite, textile, fabric, glass, or other extruded, woven, pleated, machined, additive manufactured, porous, buoyant, artificial, or natural materials.

Nominal opening sizes for each filter or stage may vary and may depend on local unconditioned feedwater properties and final conditioned feedwater quality targets, e.g., a first wedge wire screen with 1-mm openings and a second woven textile with 1-um openings may remove non-living solids within a nominal size range of 0.001-mm to 1-mm. Further, a total open area and surface area of each filtration stage should be sized to minimize pressure drops, which should generally be maintained below an intake pressure drop limit of pump 114 or system 100.

As shown, in an intake, or forward mode of operation, one or more pumps 114 may operate in a forward direction to create a pressure differential and draw in a flow of surrounding water 108 with suspended solids 106 into, and generally normal to, each filter of intake subsystem 110. In operation, an approach velocity of surrounding water 108 entering intake subsystem 110 should be maintained below a critical impingement velocity, e.g., in the United States, at less than 0.5 ft/s according to U.S. Environmental Protection Agency guidelines.

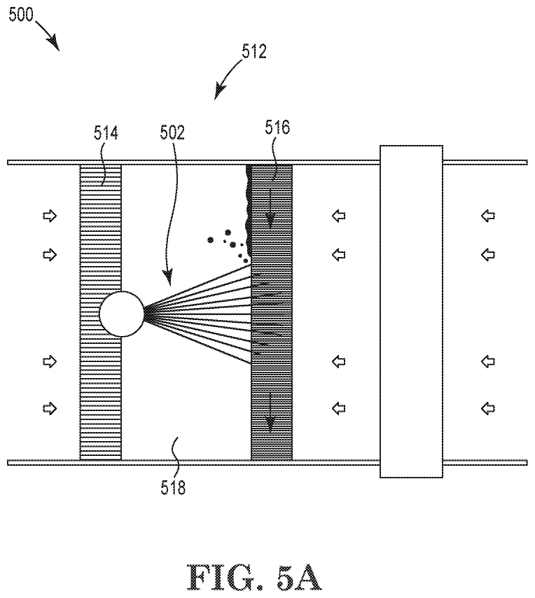

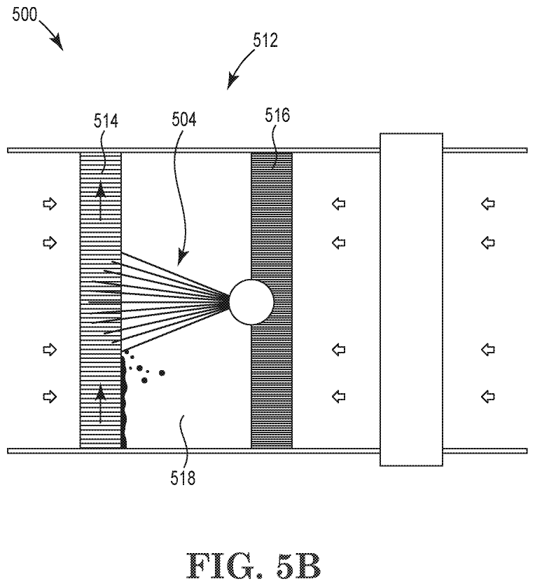

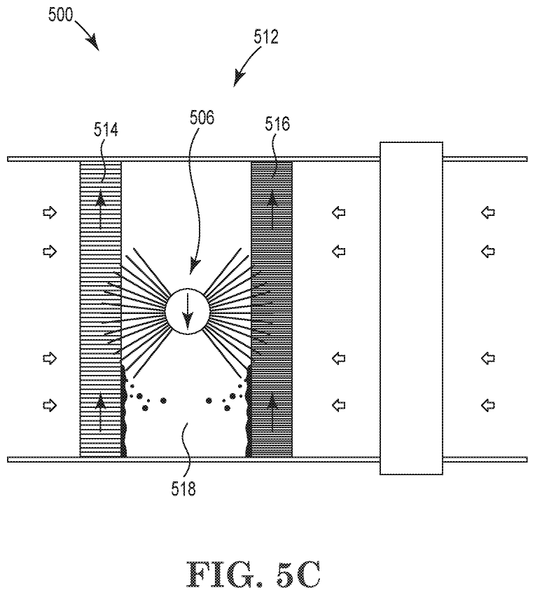

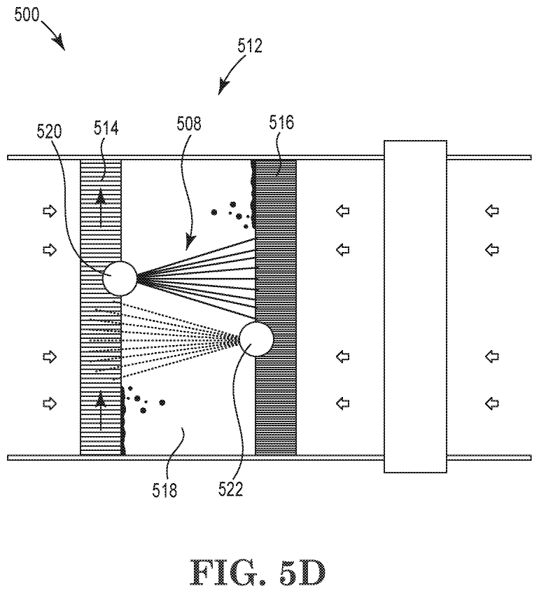

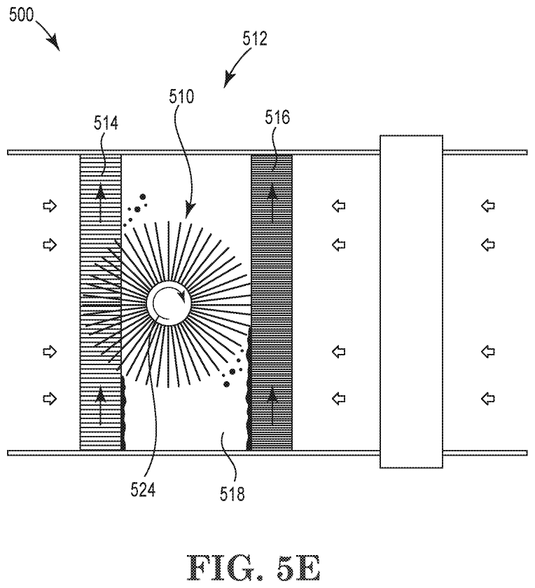

As the flow of surrounding water 108 is received, two or more successive filters, with decreasing or finer porosities, of intake subsystem 110 may entrap or capture suspended solids 106, e.g., microplastics, within an interstitial space between filters. In turn, as suspended solids 106 become entrained, impinged, or otherwise captured within the interstitial space, a cleaning subsystem may operate to clean or otherwise displace solids 106 from the filter surfaces, as will be discussed below in more detail in FIGS. 5A-5E. The disclosed cleaning subsystem may include one or more brushes, blades, or water jets within an interstitial space that sweep or spray across an interior or outer surface of the filtration stages to dislodge impinged solids. In operation, a drive assembly, e.g., motor, gearbox, etc., may force rotation or translation of the cleaning devices or the filtration stages relative to each other.

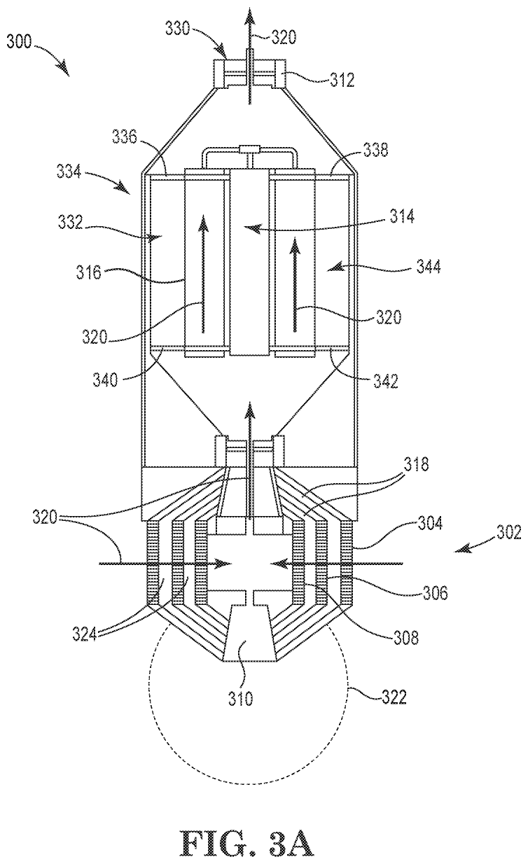

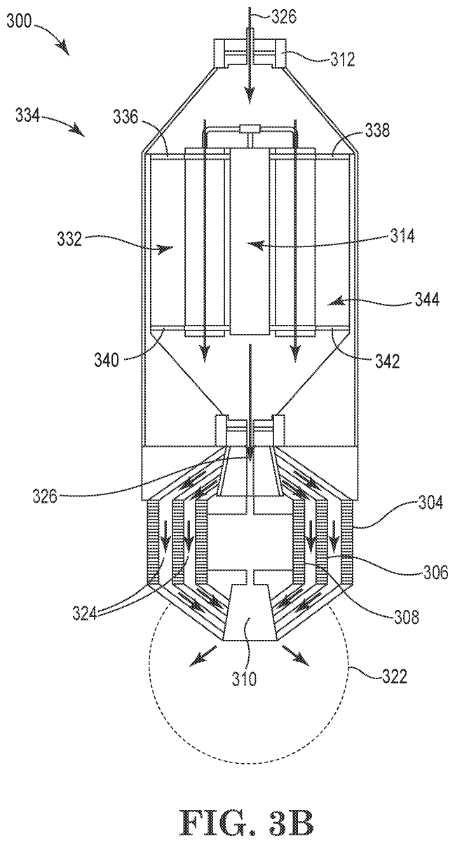

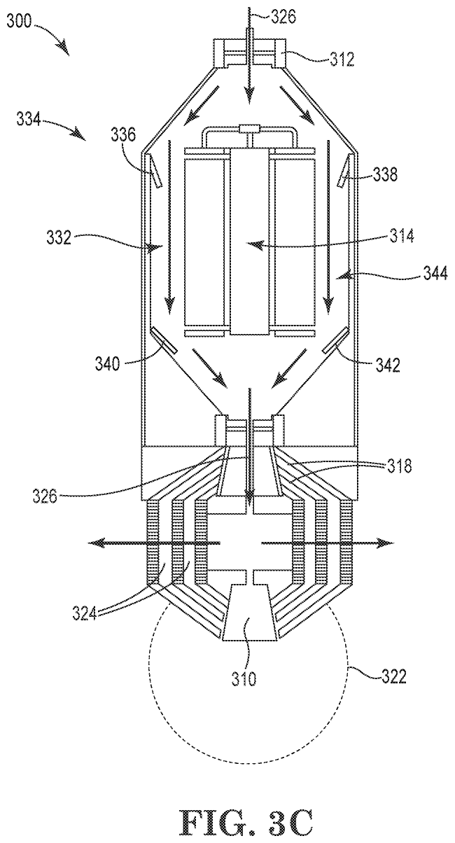

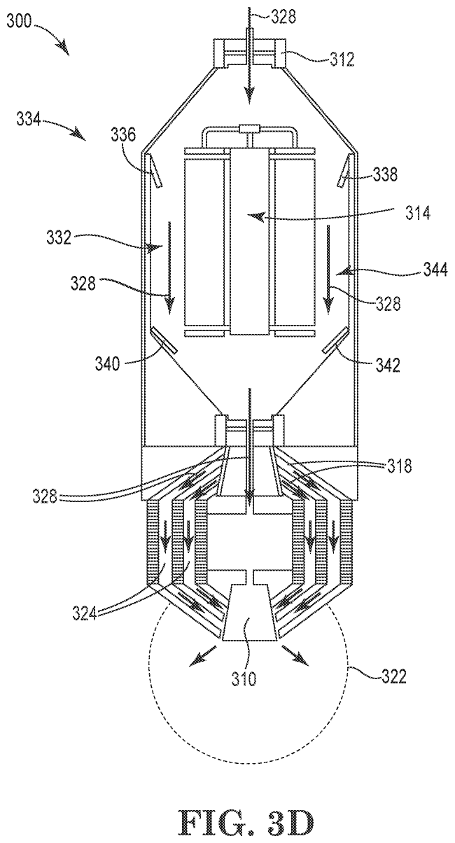

As interstitial fluid passes through successive filter(s) of intake subsystem 110, the fluid may possess a greater through velocity as compared to an entry of surrounding seawater, e.g., greater than 0.5 ft/s. After passing through the two or more successive filter(s), filtered water may be provided to any number of internal or external downstream applications 120. For example, as will be discussed in FIGS. 3A-3C, system 100 may include one or more internal desalination membranes or cartridges within housing 112 that receive the flow of filtered water from intake subsystem 110, filter out salt or other mineral components from the filtered water, and provide a flow of desalinated water through outfall 116 to external downstream applications 120, e.g., a filtration assembly umbilical 132, onshore application 134, surrounding water 136, or any other external application 138.

After a detected qualifying event, e.g., passage of time, determination or estimation of particulate capture, measurement of pressure drop, or other indicator of potential filter clogging or failure, system 100 may operate in a second mode of operation (backflush or backwash mode of operation) to displace and transport suspended solids 106 into collection subsystem 122.

FIG. 1B illustratively shows a submerged, multi-stage water filtration system operating in a second, backflush or backwash, operating mode in accordance with an embodiment of the present invention. As shown, one or more pump(s) 114 may operate in reverse to drive a flow of filtered water backwards through internal fluid passageways, interstitial space(s), and into collection subsystem 122. As a result, impinged solids may be safely transported from interstitial space(s) to collection subsystem 122.

In some examples, in a cleaning, backflush or backwash mode of operation, one or more valve(s) of a valve assembly, e.g., piston valves, backwash valves, one-way valves, check valves, actuated valved, Tesla valves, and the like, may be opened, closed, or left idle to allow a flow of filtered fluid to travel through one or more internal passageways, interstitial space(s), and into collection subsystem 122. Valves may include any number of moving or non-moving components. Further, a valve assembly may include a one-way valve positioned along discharge outlet 118 to control or restrict an ingress of received interstitial fluid from re-entering system 100.

Collection subsystem 122 may take the form of one or more fixed or detachable containers, bladders, microporous bags, or receptacles coupled to discharge outlet 118. Any number of fastening mechanisms may be used to physically couple subsystem 122 to outlet 118, e.g., latches, bolts, screws, welds, etc. Depending on a backwash or backflush mode of operation, and number of suspended solids 106, collection subsystem 122 may employ a variety of materials, shapes, and sizes. For example, in heavily polluted waters, a large elastomeric container may be used to entrap a higher quantity of suspended solids 106. However, other materials, e.g., metals or plastics, and other shapes may be used in collection subsystem 122.

In some examples, as shown in FIG. 1B, a separating component 142 with a chamber 146 and attractant(s) 148 may also be fluidically coupled to collection subsystem 122 for separating living and non-living solids. For example, as shown, source water 108 may include living 140 and non-living solids 106, e.g., microplastics. In an intake, or first, mode of operation, a flow of non-living solids 106 and living solids 140 may enter intake subsystem 110 and become entrained or otherwise impinged within an interstitial space of the multi-stage filtration subsystem. To safely separate out and release, while still alive, the captured living solids 140, system 100 may operate in a backwash or backflush mode of operation to safely transport living 140 and non-living 106 solids to collection subsystem 122.

Once in collection subsystem 122, living solids 140 may migrate into chamber 146 via conduit 144 which fluidically couples collection subsystem 122 to microorganism collection or separating subsystem 142. Migration of living solids 140 can be encouraged using a suitable attractant 148 for luring mobile, living solids 140 into chamber 146. Once in container 146, living solids 140 may freely return to surrounding water 108 through an open conduit 150 fluidically coupled to chamber 146. Attractant 148 may for example be a light emitting diode (LED) or other light emitting device that emits a wavelength of light suitable for attracting zooplankton or other living solids 140; a food source, e.g., diatoms, green algae or brown algae; or any other attractant capable of luring living solids 140. A TekTite™ Mark III 4-LED 360-degree light represents an exemplary attractant.

Depending on a size and shape of containers 122 and 146, multiple attractants 148 or combinations of different attractants may be used. For example, for relatively large containers, attractants 148 may include one, or both of, food and LEDs positioned within container 146. Such attractants 148 may be positioned in a hanging manner, embedded within a body of container 146, or positioned at any number of locations within container 146.

Once in container 146, living solids 140 may safely traverse open conduit 150 and return to surrounding water 108 while suspended non-living solids 106 remain in collection subsystem 122. In turn, solids 106 may be safely removed from collection subsystem 122 or converted to a non-suspended form using a variety of techniques. For example, a remote operated vehicle (ROV) may couple to collection system 122 and remove suspended solids 106 from collection subsystem 122. Removal can be carried out using a pump on the ROV, or by using a pump in system 100 and suitable valving to direct filtered water into collection subsystem 122. In other embodiments, ROV may detach collection system 122 from system 100 and transport collection subsystem 122 topside (viz., above water surface 104) or to a desired disposal site. A user may also raise system 100 proximate to or above water surface 104 and manually remove or detach collection subsystem 122 and, in turn, remove captured solids 106 from collection subsystem 122.

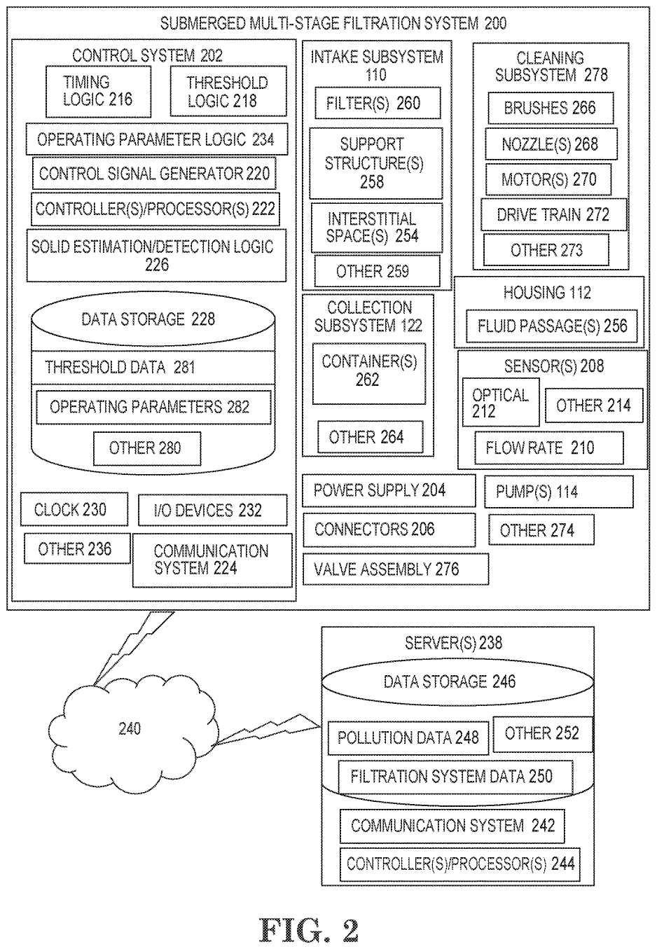

FIG. 2 is a block diagram of a submerged, multi-stage water filtration system in accordance with an embodiment of the present invention. As illustratively shown, a submerged, filtration system 200 may include many of the same components as system 100, e.g., a housing 112, pump(s) 114, intake subsystem 110, collection subsystem 122, valve assembly 276, and cleaning subsystem 278. However, as shown, system 200 further includes a control system 202, a power supply 204 for supplying electrical or hydraulic power to one or more components of system 200, connector(s) 206, e.g., hot stab or wet mate connector(s), for receiving and supplying electrical and hydraulic power, and sensor(s) 208 for detecting an operating characteristic of system 200 or a presence of suspended solids. Sensor(s) 208 may include flow rate sensors 210, optical sensors 212, or any other sensor(s) 214 capable of detecting a presence or absence of suspended solids or an operating characteristic of system 200.

While control system 202, and components thereof, are illustratively shown within system 200, it is expressly contemplated that control system 202, or any components thereof, may be located topside, onshore, or remote from filtration system 200. System 202 may include timing logic 216, threshold logic 218, a control signal generator 220, controller(s) or processor(s) 222, a communication system 224, solid estimation/detection logic 226, data storage 228, clock 230, I/O devices 232, operating parameter logic 234, and any other logic or components 236. It is to be understood that control system 202 and components thereof may be stored remotely on server 238, and accessible over a network 240, or locally within storage 228. While a singular server 238 is shown, it is to be understood that control system 202 may be located across multiple servers as well. Server(s) 238 may include a communication system 242, controllers/processors 244, and data storage 246 with pollution data, 248, filtration system data 250, or any other data 252.

Moreover, it is to be understood that any or all logic of system 202 may be stored as computer readable instructions on a memory 228 that, when executed by controller(s) or processor(s) 222, causes controller(s) or processor(s) 222 to perform the computer-implemented steps described herein. Further, it is to be understood that components of system 202 may take the form of software or hardware capable of carrying out the functions described in the present application. Other components 236 may be included as well such as any number of drivers, operating systems, network settings, location systems, power supplies, and the like.

Communication system 224 may take the form of any devices, e.g., transceivers, wireless or wired communication modules, or bus that allows control system 202 or components thereof to communicate with server 238 and each other. I/O devices 232 may include display devices, buttons, and the like for receiving user inputs and displaying information.

In operation, upon detecting one or more qualifying events, control system 202 may switch operating modes of filtration system 200 through the generation of one or more control signals, e.g., operating one or more pump(s) 114 in reverse to redirect a flow of filtered water through interstitial space(s) 254 and collection subsystem 122. As noted above, qualifying events may include a passage of time, a detection or estimation of suspended solids within an interstitial space, and other parameters that will be apparent upon reading this disclosure. For example, timing logic 216 may receive one or more signals from clock 230 and control signal generator 220 indicative of a passage of time and operating parameter(s) of pump(s) 114. From the received signals, timing logic 216 may determine an operating duration in a forward, cleaning, backflush or backwash mode of operation. Operating durations may be measured based on time, flow volumes, or other appropriate parameters.

As operating durations and parameters are determined, timing logic 216 may generate one or more outputs for threshold logic 218 to determine whether a current operating mode has exceeded a desired time threshold. For example, stored threshold values may be stored locally within data storage 228 or remotely on server(s) 238 and indicate that system 200 is to operate in a first (viz., forward) operating mode for 2, 3, 4, 5 minutes or hours; acre-feet of product water; or other suitable duration. If threshold logic 218 indicates that system 200 has exceeded a threshold value, threshold logic 218 may generate one or more output(s) for operating parameter logic 234 to determine a desired operating mode, e.g., a continued forward mode or a change to a cleaning, backflush or backwash mode of operation.

Desired operating modes may be stored locally or remotely and take the form of a table setting forth a range of exceeded thresholds and corresponding operating parameters. For example, an exceeded threshold of 2 minutes in a forward operating mode may indicate system 200 is to operate in a backflush mode of operation. Alternatively, an exceeded threshold of 5 minutes in a forward operating mode may indicate system 200 is to operate in a backwash mode of operation.

Once one or more desired operating parameters are identified, operating parameter logic 234 may generate an output to control signal generator 220 to operate pump(s) 114 or other electro-mechanical or mechanical subsystems, e.g., motors, etc., at the identified parameters. In turn, control signal generator 220 may generate one or more control signals to modify an operating parameter of system 200. The control signals accordingly may switch apparatus 200 among forward, cleaning, backflush and backwash modes of operation.

Qualifying events may also include an estimation or detection of suspended non-living solids and living solids within an interstitial space 254 or fluid passage(s) 256. For example, sensor(s) 208 coupled to interstitial space 254 or fluid passage(s) 256 may generate signal(s) indicative of a quantity of suspended non-living solids and living solids within interstitial space 254 or passage(s) 256. Specifically, sensor(s) 208 may include optical sensor(s), e.g., photodetectors, spectrometers, high-resolution cameras or other sensors configured to continuously, or intermittently, evaluate fluid within interstitial space 254 or passage(s) 256. Once generated, the resultant measurements or imaging data may be provided to solid estimation/detection logic 226.

Based on the received measurements or images, solid estimation/detection logic 226 may detect or estimate a quantity of suspended solids within interstitial space(s) 254 or fluid passage(s) 256. For example, suspended solids may show up in images as different colored solids, specks, etc. By counting the individual solids, or using other suitable mathematical relationships, solid estimation/detection logic 226 may detect or estimate a quantity of suspended solids. Further, in some embodiments, such information may be supplemented by received pollution data 248 from server 238. For example, pollution data 248 may indicate a high concentration of suspended solids, e.g., microplastics, at the operating depth and position of system 200. Such information may be used to more accurately detect or estimate a quantity of suspended solids.

For example, solid estimation/detection logic 226 may generate one or more outputs for operating parameter logic 234. Based on the estimated or detected quantity of suspended solids, operating parameter logic 234 may determine corresponding operating parameters for system 200. Corresponding operating parameters may for example take the form of a table setting forth quantities of suspended solids and operating parameters of system 200. For example, an estimate of 10⁴ solids/cm³ may correspond to a backflush mode of operation while an estimate of 10² solids/cm3 may correspond to a forward intake mode of operation. It is to be understood that any quantity of solids may be mapped to any operating mode. Once determined, operating parameter logic 234 may generate one or more outputs for control signal generator 220 to operate system 200 at the desired parameters. While qualifying events in the form of timing and a quantity of suspended solids are discussed, it is contemplated that additional or different qualifying events may be used as well.

FIG. 3A illustratively shows a forward or first operating mode of a submerged, multi-stage water filtration system with desalination membrane(s) in accordance with an embodiment of the present invention. As noted above, while system 300 illustratively includes desalination membranes 316, it is to be understood that this is by way of example only, and any number of downstream processes may be used in place of, or in combination with, desalination membranes 316. Specifically, as noted above, filtered water, once through an intake subsystem, may pass directly to downstream applications, e.g., applications 120, with or without passing through desalination membranes 316 or additional processing devices, e.g., by passing through one or more bypass channels 332 and 344. However, in this example, system 300 illustratively includes an intake subsystem 302 with an outer screen 304 and two successive concentric cylindrical filters 306 and 308, a valving assembly 310, e.g., piston valve, operable between a first and second position, one or more pumps 312 for drawing in a flow of surrounding water through intake subsystem 302, a permeate pump 314 for extracting freshwater through reverse osmosis membranes 316, a plurality of fluid passageways 318 coupled to interstitial spaces 324, and a bypass subsystem 334 with bypass valve(s) 336, 338, 340, and 342 and channels 332 and 344 for modifying fluid passage through system 300.

In operation, system 300 may operate similarly to system 100 to produce filtered water and remove or otherwise capture suspended solids, e.g., microplastics, from surrounding water. Specifically, in a first, intake, operating mode, one or more pump(s) 312 may operate in a forward manner to create a pressure differential that draws in a flow of surrounding water through intake subsystem 302 along path 320. In turn, suspended solids may become impinged onto filters 306, 308 or otherwise entrapped within interstitial spaces 324. Once through intake subsystem 302, filtered fluid may flow to one or more downstream internal desalination membrane elements 316, filter(s), etc., or directly to downstream application(s) without further processing, e.g., by passing through bypass channels 332 and 344,.

Specifically, in a first operating mode, piston valve 310 may operate in a first position to abut or otherwise rest against fluid channels 318 to block, prohibit, or restrict passage of fluid through fluid channels 318. As a result, a flow of fluid may flow along fluid path 320, through filter(s) 304, 306, 308, and into desalination membranes 316 as bypass valve(s) 336, 338, 340, and 342 remain closed. However, in some embodiments, bypass valve(s) 336, 338, 340, and 342 may be opened to permit filtered fluid passage directly to downstream applications without desalination or processing.

To maintain a first operating position of valve 310, one or more pump(s) 312 may operate at heightened operating characteristics for creating sufficient internal filtered fluid flow rate or pressure to act on and maintain an operating position of valve 310. Specifically, as fluid passes along path 320, filtered fluid may aggregate towards the central axis center of system 300 and act on, and bias, valve 310 in an upwards direction as the filtered fluid travels to internal filters 316.

While a piston valve 310 is shown, in other embodiments, valve 310 may include one or more one-way valves, e.g., Tesla valves, check valves, etc., positioned within each fluid channel 318 with or without a piston valve. In these embodiments, each one-way valve may be configured to permit fluid passage during a second, cleaning, backwash, or backflush mode of operation while restricting fluid passage during a first, intake, operating mode. However, any number and types of valves may be used in accordance with the present invention. As noted above, after a qualifying event, it may be desirable to operate system 300 in a cleaning or backwash mode.

FIG. 3B illustratively shows a cleaning operating mode of a submerged, multi-stage water filtration system with desalination membranes in accordance with an embodiment of the present invention. While a cleaning mode illustratively includes producing backpressure to dislodge impinged solids from one or more membranes, it is to be understood that, in other examples, a cleaning mode may simply include operating one or more cleaning devices, e.g., water jets, air jets, brushes, etc., to clean one or more filters 304, 306, and 308 as shown in FIGS. 5A-5E, below. However, in this example, bypass valve(s) 336, 338, 340, and 342 may remain closed as one or more pump(s) 312 operate in reverse to create a reverse flow and differential pressure through system 300 to dislodge impinged solids from membranes 316. In turn, valve 310 may be opened allowing dislodged solids to pass into interstitial spaces 324 and collection subsystem 322.

In one example, pump(s) 312 may be operated at a heightened operating parameter to position valve 310 in a second open operating position while dislodging solids from membrane(s) 316. For example, a position of valve 310 may be adjusted based on the pressure acting on valve 310. In this example, a reverse flow of fluid may have sufficient pressure to dislodge solids from membrane(s) 316 and open valve 310. Alternatively, if valve(s) 310 include one or more one-way valve(s) in one or more fluid channels, e.g., channels 318, such valve(s) may simply be opened to permit passage through interstitial space(s) 324 and collection subsystem 322.

FIG. 3C illustratively shows another cleaning operating mode of a submerged, multi-stage water filtration system with desalination membranes in accordance with an embodiment of the present invention. In this embodiment, during a cleaning event, one or more bypass valve(s) 336, 338, 340, and 342 may be opened to allow for fluid passage through bypass channels 332 and 344. As a result, one or more pump(s) 312 may provide a greater flow velocity and pressure during a cleaning mode of operation. Specifically, without having to pass through membrane(s) 316, heightened flow pressures and velocities may be obtained to more adequately dislodge impinged solid(s) from filter(s) 304, 306, and 308 as a flow of fluid passes through filter(s), interstitial spaces, and is returned to a surround body of water along flow path 326.

FIG. 3D illustratively shows a backwash or backflush operating mode of a submerged, multi-stage water filtration system with desalination membranes in accordance with an embodiment of the present invention. As shown, in a backwash or backflush operating mode, bypass valve(s) 336, 338, 340, and 342 may be opened and one or more pump(s) 312 operated at heightened operating parameter(s) to modify an operating position of valve 310 and, in turn, allow for fluid passage through passages 318, interstitial space(s) 324, and into collection subsystem 322, along path 328. Specifically, pressurized filtered fluid may act on, and bias, valve 310 in a downwards direction to a second open operating position. While in the second position, fluid channels 318 may be unblocked allowing for filtered fluid to travel through channels 318 and interstitial spaces 324 into collection subsystem 322. In some examples, as noted above, rather than biasing valve 310, one or more one-way valve(s) may be positioned in fluid channels 318 and opened to allow for fluid passage through interstitial spaces 324 and collection subsystem 322.

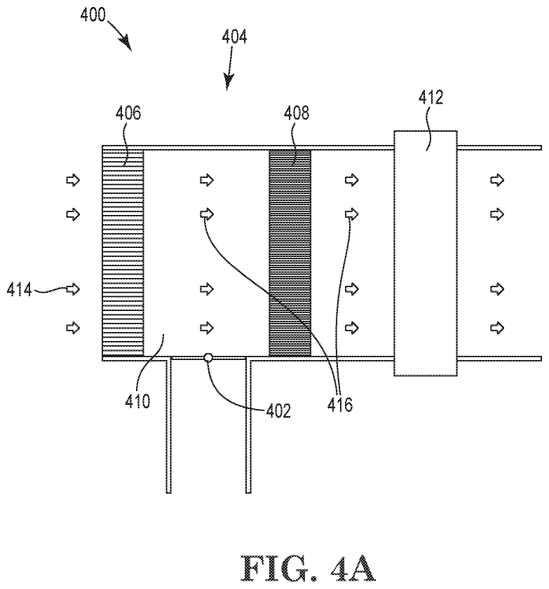

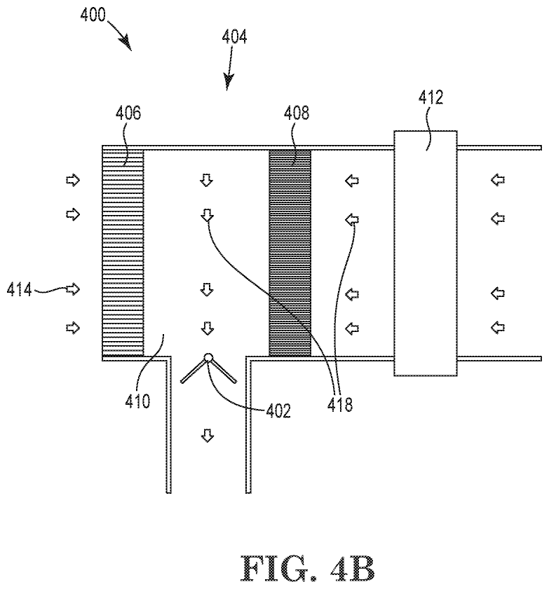

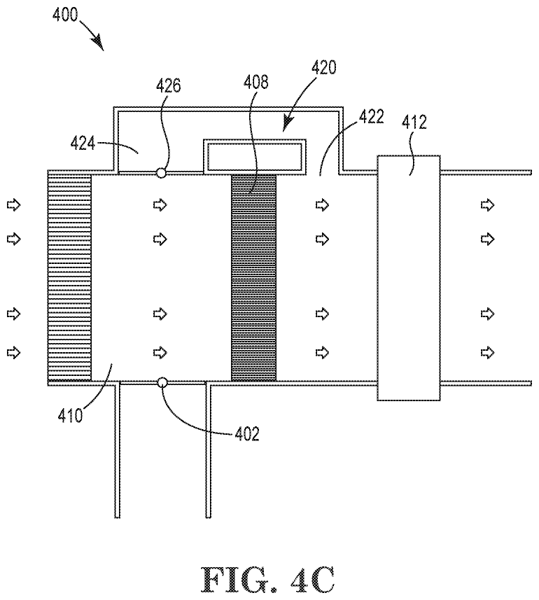

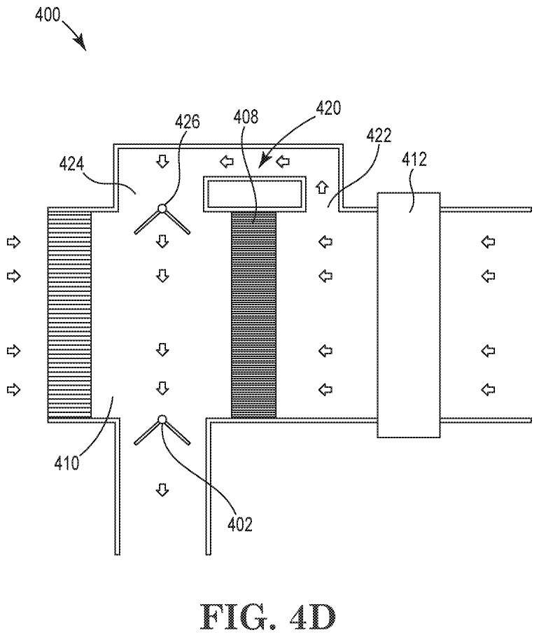

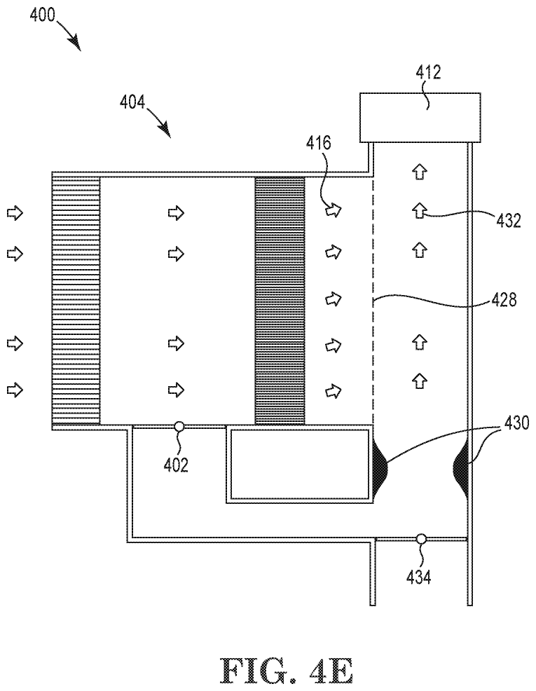

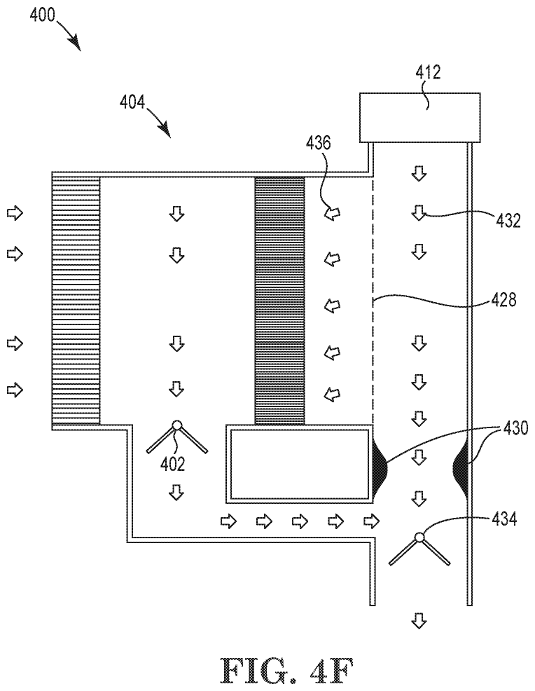

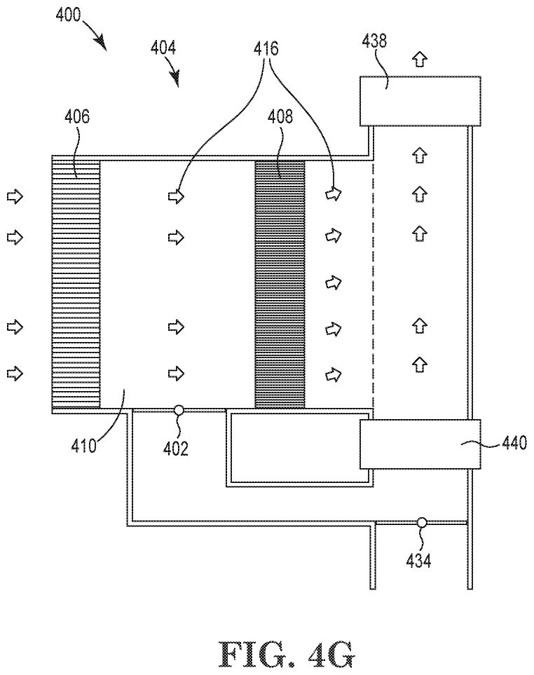

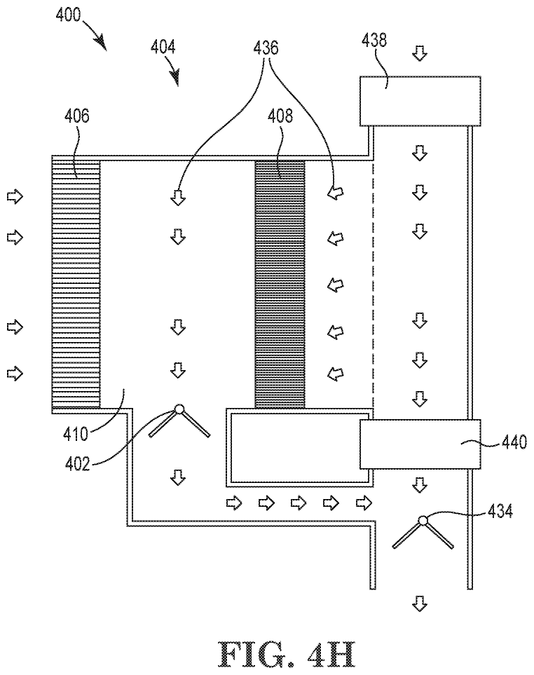

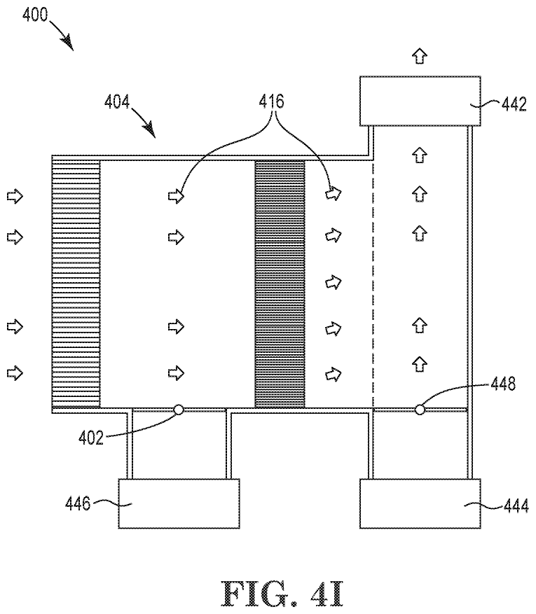

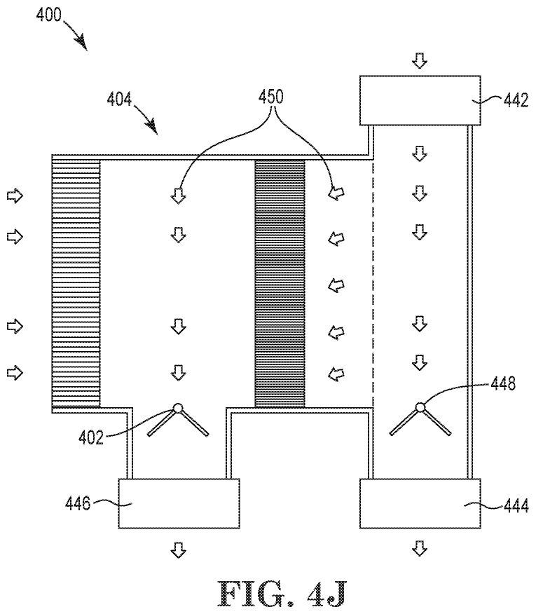

FIGS. 4A-4J illustratively show various submerged, multi-stage water filtration systems in accordance with embodiments of the present invention. Beginning with FIGS. 4A-4B, a filtration system 400 illustratively includes a valve 402 for directing a fluid pathway, an intake subsystem 404 with a plurality of successive filters (stages) 406, 408 and an interstitial space 410 for capturing suspended solids, e.g., microplastics, and a pump 412 for creating a pressure differential and flow through system 400.

As shown in FIG. 4A, in a first operating mode, pump 412 may be driven forward by a control system (not shown) to draw in surrounding water 414 along pathway 416. As water is drawn in, suspended solids, e.g., microplastics, may be captured within interstitial space 410 or otherwise impinged onto a surface of filters 406, 408. As noted above, once through filter 408, filtered water may be provided to any number of downstream internal or external applications (not shown).

In a backwash operating mode, as shown in FIG. 4B, a control system (not shown) may open valve 402 and operate pump 412 in reverse to direct a flow of filtered water along a path 418 through filter 408 and interstitial space 410 into a collection subsystem (not shown).

Turning to FIGS. 4C and 4D, in some embodiments, submerged multi-stage filtration system 400 may further include a passageway 420 with an inlet 422 and outlet 424 and a valve 426 for supplying a flow of filtered water directly through interstitial space 410 without having to traverse filter 408. In this embodiment, as shown in FIG. 4C, a control system (not shown) may close a valve 426 in a first operating mode and, in a second operating mode, open valve(s) 402, 426 and redirect pump(s) 412 as shown in FIG. 4D. As a result, filtered fluid may be supplied to interstitial space 410 through passageway 420 without having to traverse filter 408.

In some embodiments, as shown in FIGS. 4E and 4F, submerged multi-stage filtration system 400 may also include a flow modifier 428 and a flow restrictor 430. As shown in FIG. 4E, in a forward operating mode, flow modifier 428 may evenly distribute a flow path 416 and convey a distributed flow of water 432 to an internal downstream application (not shown), e.g., a subsea reverse osmosis process, filters, etc. As shown in FIG. 4F, in a backwash, or second, operating mode, a control system (not shown) may open valve(s) 402, 434 and operate pump 412 in reverse to direct a flow of filtered water along a flow path 436. In turn, flow restrictor 430 may modulate path 436 towards an outlet and a collection subsystem (not shown). Specifically, restrictor 430 may partially constrict and then rapidly expand path 432 to accelerate a velocity of fluid in path 432 such that an increased fluid velocity induces a pressure drop and corresponding flow of fluid similar to the mechanisms of Venturi-type or pitot-type flow restrictors.

While one pump 412 has been shown and described, it is to be understood that any number of pump(s) may be used. For example, as shown in FIGS. 4G-4J, submerged multi-stage filtration system 400 may include a plurality of pumps. Specifically, in one embodiment, as shown in FIGS. 4G-4H, system 400 may include two pump(s) 438 and 440. In a forward mode of operation, a control system (not shown) may operate pump 438 in a forward direction and turn off pump 440. In turn, a flow of fluid may travel along path 416 through each filtration stage 406,408 to produce a flow of filtered water and capture suspended solids within interstitial space 410. Alternatively, as shown in FIG. 4H, in a backwash, or second, mode of operation, a control system may turn on pump 440 and operate pump 438 in reverse to produce a pressure drop and drive filtered and interstitial fluid along a flow path 436 to a collection subsystem (not shown). In this example, valve(s) 402 and 434 may remain closed in a forward operating mode and opened in a backwash or backflush operating mode. Alternatively, in some embodiments, rather than operating pump 438 in reverse, the control system may turn off pump 438 in a backwash operating mode. As a result, only pump 440 may drive a flow of filtered and interstitial fluid towards a collection subsystem (not shown).

In some embodiments, as shown in FIGS. 4I and 4J, system 400 may include three pumps 442, 444, and 446. In this example, in a forward operating mode, pump 442 may drive a flow of fluid along path 416 while pumps 444 and 446 remain off and valves 402 and 448 are closed. As shown in FIG. 4J, in a backwash, or second, operating mode, a control system may open valves 402 and 448 and turn on pumps 444 and 446. In turn, interstitial fluid and filtered fluid may travel along path 450 to a collection subsystem (not shown). In this mode of operation, pump 442 may be turned off or operated in reverse.

FIGS. 5A-5E illustratively show a cleaning subsystem of a submerged multi-stage filtration system in accordance with embodiments of the present invention. As shown in FIGS. 5A-5E, a submerged multi-stage filtration system 500 may include a cleaning subsystem 502, 504, 506, 508, and 510 coupled to an intake filter subsystem 512 for removing and displacing impinged solids from a surface of either or both filter(s) 514 and 516. While FIGS. 5A-5E illustratively show cleaning subsystem operating in a backwash, or second, operating mode, it is to be understood that such systems may operate in a forward or cleaning mode of operation as well.

As shown in FIGS. 5A-5E, cleaning subsystems 502, 504, 506, 508, and 510 may be positioned on any filter, e.g., filter 514 and 516, or within an interstitial space 518 and take the form of brushes, blades, water jets, or air burst devices. In operation, subsystems 502, 504, 506, 508 and 510 may clean and contact only one filter, as shown in FIGS. 5A and 5B, or multiple filters as shown in FIGS. 5C-5E. Further, it is to be understood that any combination of cleaning devices may be used as well. For example, as shown in FIG. 5D, cleaning subsystem 508 may include a brush 520 and water or air jet 522 for sweeping an outer surface of filter 516 and spraying an inner surface of filter 514. Any combination, number, and type of cleaning modules may be used in accordance with the present invention.

Further, in some embodiments, as shown in FIG. 5E, cleaning subsystems, e.g., subsystem 510, may also be passively or actively driven by a drive mechanism (not shown) to rotate along a cleaning axis 524. For example, a drive mechanism may be necessary to impart movement to cleaning subsystems or filters to adequately clean each filtration stage. A drive mechanism may include any number of drive chains or belts, motor drive gears, screen gear boxes, motors, etc. to elicit rotational or translational movement of filters 514 and 516, and, passively or actively, cleaning subsystem 510. This may ensure that all, or substantially all, suspended solids are safely and effectively removed from filters 514 and 516 and suspended within an interstitial space 518. In some embodiments, active driving movement of one or more filters 514 and 516 may passively drive cleaning subsystems, e.g., subsystem 506 in FIG. 5C. Specifically, a drive mechanism may include a drive train coupled to one or more filters 514 and 516 to actively impart movement to filters 514 and 516. In turn, as filters 514 and 516 move (e.g., translate or rotate), cleaning subsystems coupled to filters 514 and 516 may passively rotate to ensure proper and adequate cleaning.

Having thus described preferred embodiments of the present invention, those of skill in the art will readily appreciate that the teachings found herein may be applied to yet other embodiments within the scope of the claims hereto attached. The complete disclosure of all patents, patent documents, and publications are incorporated herein by reference as if individually incorporated.

1. A submerged, multi-stage filtration system for capturing suspended solids from a water source, the system comprising:
a source water intake;
first and second system outlets;
at least one pump;
an intake filter subsystem fluidically coupled to the source water intake and the at least one pump, the intake filter subsystem configured to receive a flow of source water, capture suspended non-living solids and living solids from the flow of source water, and produce a filtered flow of water; and
a collection subsystem fluidically coupled to the second system outlet and configured to capture non-living solids and living solids and separate non-living solids from living solids;
wherein the system is configured to operate in a plurality of operating modes, and in a first operating mode, the filtered flow of water is provided along a first fluid pathway to produce filtered water at the first system outlet; and in a second operating mode, the filtered flow of water is provided along a second fluid pathway to wash captured non-living solids and living solids into the collection subsystem and release living solids through the second system outlet back into the water source.

2. The filtration system of claim 1, wherein the intake filter subsystem comprises:
a plurality of filters separated by interstitial space(s) defining a fluid flow path between a downstream face of an upstream filter and an upstream face of a downstream filter,
and wherein the second fluid pathway comprises the interstitial space and flow across the downstream and upstream filter faces to the second system outlet.

3. The filtration system of claim 2, further comprising:
a self-cleaning subsystem coupled to the intake filter subsystem configured to remove suspended non-living solids and living solids from the plurality of filters and capture suspended non-living solids and living solids within the interstitial space.

4. The filtration system of claim 3, wherein the self-cleaning subsystem comprises at least one of brushes, blades, pistons, water jets, or air bursts.

5. The filtration system of claim 1, wherein the collection subsystem comprises at least one of a fixed or detachable container, bladder, microporous bag, or receptacle.

6. The filtration system of claim 1, wherein the collection subsystem is fluidically coupled to a separating component via a conduit for separating living solids from non-living solids.

7. The filtration system of claim 1, wherein the collection subsystem comprises an attractant for luring and returning living solids back into the source water.

8. The filtration system of claim 7, wherein the attractant comprises a light emitting device.

9. The filtration system of claim 7, wherein the attractant comprises a food source.

10. The filtration system of claim 1, wherein the at least one pump comprises a reversible pump configured to operate in the first mode to receive the flow of source water and in the second operating mode to return the living solids to source water.

11. The filtration system of claim 1, wherein the first operating mode comprises a continuous flow of source water through the filtration system to produce a continuous flow of filtered water.

12. The filtration system of claim 1, wherein the second operating mode is configured to occur intermittently based on a detected triggering event comprising at least one of an estimated or identified presence of suspended particulates within the system.

13. The filtration system of claim 1, wherein the first and second operating modes have cycle lengths and the first operating mode cycle length is longer than the second operating mode cycle length.

14. The filtration system of claim 1, further comprising:
at least one desalination system fluidically coupled to the intake filter subsystem and the at least one pump, the at least one desalination system configured to receive a filtered flow of seawater and produce a flow of brine and desalinated water.

15. The filtration system of claim 14, wherein the at least one desalination system comprises:
at least one reverse osmosis membrane configured to receive the filtered flow of seawater and produce the flow of desalinated water.

16. The filtration system of claim 15, further comprising:
a bypass subsystem fluidically coupled to the first and second system outlets configured to, in the first operating mode, remain in a closed position to bias the filtered flow of seawater to the at least one reverse osmosis membrane and, in the second operating mode, remain in an open position to wash captured non-living solids and living solids into the collection subsystem and release living solids through the second system outlet back into the water source.

17. The filtration system of claim 16, wherein the bypass subsystem comprises at least one valve and fluid passageway fluidically coupled to the first and second system outlets.

18. The filtration system of claim 1, wherein the system comprises a valving subsystem fluidically coupled to the first and second fluid pathways and configured to control the flow of filtered water through the first and second fluid pathways.

19. The filtration system of claim 1, wherein the system comprises at least one sensor configured to generate a sensor signal indicative of a presence of suspended particulates within an interstitial space, and at least one controller configured to receive the sensor signal and modify an operating parameter of the filtration system based on the received sensor signal.

20. The filtration system of claim 1, wherein the system comprises a self-cleaning subsystem coupled to the intake filter subsystem and configured to periodically remove and displace suspended non-living solids and living solids from the intake filter subsystem into an interstitial space between successive filters.

21. The filtration system of claim 1, wherein the system prevents living solids from entering the at least one pump.

22. The filtration system of claim 1, wherein the suspended non-living solids comprise microplastics.

23. The filtration system of claim 1, wherein the disclosed system returns at least 50% of the captured living solids alive to the source water and removes at least 50% of the captured non-living solids from the source water.

24. The filtration system of claim 1, wherein the system agglomerates or encapsulates the captured non-living solids.

25. A method for capturing suspended solids from a water source, the method comprising the steps of:
flowing source water through a submerged, multi-stage filtration system comprising:
a source water intake;
first and second system outlets;
at least one pump;
an intake filter subsystem fluidically coupled to the source water intake and the at least one pump, the intake filter subsystem configured to receive a flow of source water, capture suspended non-living solids and living solids from the flow of source water, and produce a flow of filtered water; and
a collection subsystem fluidically coupled to the second system outlet and configured to capture non-living solids and living solids and separate non-living solids from living solids;
operating the system in a first operating mode comprising pumping filtered water from the intake filter subsystem along a first fluid pathway to produce filtered water at the first system outlet, and,
operating the system in a second operating mode comprising pumping filtered water along a second fluid pathway to wash captured non-living solids and living solids into the collection subsystem and release living solids into the water source through the second system outlet.
